(19) United States
(12) Patent Application Publication
(10) Pub. No.: US 2026/0307007 A1
(43) Pub. Date: Oct. 8, 2026

(54) CATALYTIC REACTOR AND SYSTEM FOR PURIFICATION OF CARBON DIOXIDE STREAMS AND METHODS OF USING THE SAME

(71) Applicant: OXY LOW CARBON VENTURES, LLC, Houston, TX (US)

(72) Inventor: Casey MORRIS, Lubbock, TX (US)

(21) Appl. No.: 19/480,947

(22) PCT Filed: May 6, 2024
(86) PCT No.: PCT/US2024/028024

§ 371 Date: Nov. 3, 2025

Related U.S. Application Data
(60) Provisional application No. 63/500,397, filed on May 5, 2023.
(60) Provisional application No. 63/500,421, filed on May 5, 2023.

(51) Int. Cl. B01D 53/86; B01D 53/14; B01D 53/76

(52) U.S. Cl. CPC B01D 53/8668; B01D 53/1425; B01D 53/1431; B01D 53/1475; B01D 53/1493; B01D 53/76; B01D 2251/202; B01D 2251/208; B01D 2252/204; B01D 2256/22; B01D 2257/102; B01D 2257/104

(57) ABSTRACT

A process for the purification of carbon dioxide streams, the process comprising a) providing a gaseous stream including carbon dioxide and oxygen, where the gaseous stream includes less than 30,000 ppmv oxygen; b) introducing a hydrocarbon fuel to the gaseous stream to thereby form a fuel-containing gaseous mixture; c) oxidizing at least a portion of the hydrocarbon fuel within the fuel-containing gaseous mixture in the presence of a catalyst and the absence of flame to thereby provide an oxygen-reduced gaseous stream, where the oxygen-reduced gaseous stream includes less than 1000 ppmv oxygen; d) introducing hydrogen or a hydrogen intermediary to the oxygen-reduced gaseous stream to thereby form a hydrogen-containing gaseous mixture; and e) oxidizing at least a portion of the hydrogen within the hydrogen-containing gaseous mixture in the presence of a catalyst to thereby substantially consume all oxygen within the hydrogen-containing gaseous stream and provide an oxygen-purified carbon dioxide stream.

This application claims the benefit of U.S. Provisional Application Ser. No. 63/500,397 filed on May 5, 2023, and U.S. Provisional Application Ser. No. 63/500,421 filed on May 5, 2023, which are incorporated herein by reference.

### FIELD OF THE INVENTION

Embodiments of the present invention provide a catalytic reactor and system for the catalytic removal of oxygen from carbon dioxide streams, as well as methods for employing the reactor and system.

### BACKGROUND OF THE INVENTION

As the desire to sequester carbon dioxide has increased, the desire to eliminate oxygen from these streams has also increased. It is known that oxygen can frustrate separation process, especially chemical separation processes that rely on reacting carbon dioxide with alkylamines (i.e. amine scrubbing). Also, potential dangers associated with the presence of oxygen within carbon dioxide streams during transport and storage have been recognized.

### SUMMARY OF THE INVENTION

One or more embodiments of the present invention provide a A process for the purification of carbon dioxide streams, the process comprising a) providing a gaseous stream including carbon dioxide and oxygen, where the gaseous stream includes less than 30,000 ppmv oxygen; b) introducing a hydrocarbon fuel to the gaseous stream to thereby form a fuel-containing gaseous mixture; c) oxidizing at least a portion of the hydrocarbon fuel within the fuel-containing gaseous mixture in the presence of a catalyst and the absence of flame to thereby provide an oxygen-reduced gaseous stream, where the oxygen-reduced gaseous stream includes less than 1000 ppmv oxygen; d) introducing hydrogen or a hydrogen intermediary to the oxygen-reduced gaseous stream to thereby form a hydrogen-containing gaseous mixture; and e) oxidizing at least a portion of the hydrogen within the hydrogen-containing gaseous mixture in the presence of a catalyst to thereby substantially consume all oxygen within the hydrogen-containing gaseous stream and provide an oxygen-purified carbon dioxide stream.

Other embodiments of the present invention provide a carbon capture process, the process comprising a) providing a flue gas, where said flue gas includes carbon dioxide, nitrogen, and greater than 3 vol. % oxygen; b) introducing a hydrocarbon fuel to said flue gas and thermally oxidizing the hydrocarbon fuel to thereby reduce a portion of the oxygen within the flue gas stream to provide a first oxygen-reduced flue gas stream including less than 3 vol. % oxygen; c) introducing a hydrocarbon fuel to said oxygen-reduced flue gas stream and catalytically oxidizing the hydrocarbon fuel to thereby reduce a portion of the oxygen within the oxygen-reduced flue gas stream to provide a second oxygen-reduced flue gas stream including less than 1 vol. % oxygen; and d) introducing hydrogen or a hydrogen-generating intermediary to the second oxygen-reduced flue gas stream and catalytically oxidizing the hydrogen to thereby reduced at least a portion of the oxygen within the second oxygen-reduced flue gas stream to provide a third oxygen-reduced flue gas stream including less than 10 ppmv oxygen.

### BRIEF DESCRIPTION OF THE DRAWINGS

FIG. 1 is an exemplary cross-sectional side view of a catalytic reactor that can be employed in practicing the invention.

FIG. 2 is a schematic diagram of a flue gas capture system employing embodiments of the present invention.

### DETAILED DESCRIPTION

Embodiments of the invention are based, at least in part, on the discovery of a multi-stage catalytic combustion process and system that employs multiple oxygen consumption stages arranged in series. A first optional stage includes the thermal combustion of hydrocarbon fuel that is introduced to a gaseous inlet stream including carbon dioxide and oxygen. The first stage is optional and may not be required where the inlet stream includes less than three percent by volume (i.e. less than 30,000 ppmv) oxygen. When employed, this first stage, which may include multiple sub-stages, produces a carbon dioxide stream having less than 3 percent by volume oxygen. In the next stage (e.g. a second stage), hydrocarbon fuel is introduced to the stream and is catalytically combusted (i.e. the hydrocarbon fuel is oxidized in the presence of a catalyst). This second stage, which may include multiple sub-stages, produces a carbon dioxide stream having about 1000 ppmv or less oxygen. In a subsequent stage, (e.g. a third stage), hydrogen, which is directly introduced to the product stream of the previous stage or introduced via an intermediary such as methanol, is catalytically oxidized to form water. This third stage, which may include multiple sub-stages, produces a carbon dioxide stream that is essentially free of oxygen.

Practice of the present invention offers several advantages. For example, a product stream that includes a relatively high concentration of carbon dioxide and is at least substantially free of oxygen can be produced. Further, practice of the invention produces heat that can be captured and used in a variety of applications including, but not limited to, process heat, heat energy to drive rotary power, and heat to regenerate chemical absorption processes, such as amine capture systems. Also, where there is a desire to further purify the carbon dioxide stream, such as by separating the carbon dioxide from nitrogen, practice of the present invention offers efficiencies relative to carbon dioxide separation since the stream produced by the process and system of the present invention has higher concentrations of carbon dioxide, which is advantageous for membrane separation, and/or is free of oxygen, which, for example, can interfere with systems such as amine capture.

### Process and Reactor Overview

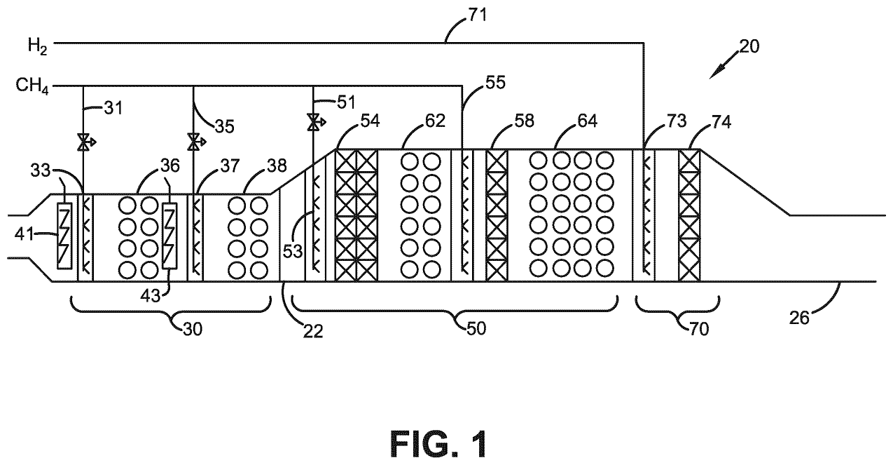

An exemplary multi-staged catalytic combustion process according to embodiments of the invention, which process may also be referred to as a multi-stage carbon dioxide purification process, can be described with reference to FIG. 1, which shows multi-stage reactor 20 including a first stage 30, a second stage 50, and a third stage 70. As described above, first stage 20 is optional, and its use may depend on the oxygen content of the input carbon dioxide stream. Reactor 20 includes housing 22, which includes inlet 24 and outlet 26. As shown, first stage 30 includes first and second fuel feeders 33, 37, which are fed by fuel lines 31 and 35, respectively. In one or more embodiments, first stage 30 includes flame combustion, and therefore first and second fuel feeders feed hydrocarbon fuel (e.g. methane) to respective direct burners. In one or more embodiments, combustion air (e.g. air or oxygen blended with the fuel) may also be fed to the respective burners. In other embodiments, first stage 30 includes flameless combustion, and therefore first and second fuel feeders introduce fuel into the first stage downstream of heaters 41, 43 (e.g. electric heaters 41, 43). First stage 30 also includes first heat exchanger 36 downstream of first fuel feeder 33 and a second heat exchanger 38 downstream of second fuel feeder 37.

Second stage 50 includes a first catalytic bed 54 and a second catalytic bed 58. A first hydrocarbon fuel feeder 53 is positioned upstream of first catalytic bed 54 and is fed by fuel line 510. A second hydrocarbon fuel feeder 57 is positioned upstream of second catalytic bed 58 and is fed by fuel line 55. Second stage 50 includes first heat exchanger 62 downstream of first catalytic bed 54 and a second heat exchanger 64 downstream of second catalytic bed 58.

Third stage 70 includes a first catalytic bed 74 positioned downstream of hydrogen fuel feeder 73, which is fed by hydrogen fuel line 71. As alluded to above, hydrogen fuel feeder 73 can feed hydrogen gas or an intermediary such as methanol.

During operation, a gaseous inlet stream containing carbon dioxide and oxygen enters reactor 20 at inlet 24 and is introduced to first stage 30 where a portion of the oxygen within the stream is thermally combusted by oxidizing the hydrocarbon fuel introduced from first fuel feeder 33. At least a portion of the heat generated by this first sub-stage is recovered at first heat exchanger 36. The gaseous stream continues downstream through first stage 30 and, where desired, a portion of the remaining oxygen within the stream is thermally combusted by oxidizing fuel introduced from second fuel feeder 34. At least a portion of the heat generated by this second sub-stage is recovered at second heat exchanger 38. It will be appreciated that the configuration of the first stage, as well as the number of sub-stages within the first stage, will vary depending on a number of factors. For example, where flameless thermal combustion takes place, heat generated in the first sub-stage may be retained from the first sub-stage to drive thermal combustion in the second sub-stage. In other words, the heat removed by the heat exchangers (e.g. first exchanger 36) is controlled so that sufficient heat is retained to drive thermal combustion in the second sub-stage, which the skilled person will appreciate eliminates the need for downstream heaters. In one exemplary embodiment, flameless thermal combustion taking place in the first sub-stage produces an exit gas with a temperature of about 1800° F., and heat exchanger 36 is employed to remove sufficient heat to drop the temperature to about 1500° F., which is the temperature required to drive flameless thermal combustion in the next sub-stage without auxiliary heating (e.g. heat from electric heaters).

As indicated above, first stage 30 is configured to reduce the oxygen content of the inlet stream to about 30,000 ppmv or less of oxygen. It should be appreciated that where the inlet stream includes about 30,000 ppmv or less oxygen (i.e. 3 vol. % or less), first stage 30 can optionally be eliminated. The skilled person will also appreciate that the configuration of first stage 30 can be manipulated to provide one thermal combustion sub-stage or more than two thermal combustion sub-stages, depending on the oxygen concentration of the inlet stream. It may be desirable to limit the amount of oxygen consumed at any given sub-stage in order to maintain the system, and in particular the stage, within desired temperature profiles. For example, it may be desirable to control the amount of heat generated at any given combustion sub-stage to maintain the ability to recover the heat from the sub-stage. It may also be desirable to limit the amount of oxygen consumed at any given sub-stage, which correlates to the amount of fuel present for oxidation, so as to maintain the fuel level below safety limits (e.g. below the explosion limits for the fuel).

Once the oxygen concentration of the gaseous stream is reduced to about 30,000 ppmv or less, the gaseous stream is routed downstream to second stage 50 where hydrocarbon fuel is introduced to the stream from first fuel feeder 53, which may also be referred to as first hydrocarbon gas feeder 53, to form a fuel-containing gaseous mixture. This gaseous mixture then encounters first catalytic bed 54, which catalyzes the oxidation of the fuel introduced to the stream and consumes at least a portion of the oxygen entrained within the stream. In other words, oxidation takes place in the presence of a catalyst in the absence of flame. Heat generated by the catalytic combustion of the hydrocarbon fuel is recovered by first heat exchanger 62 as the stream proceeds downstream within reactor 20. Following heat removal at first heat exchanger 62, additional hydrocarbon fuel is optionally introduced to the stream from second fuel feeder 57, which may also be referred to as second hydrocarbon gas feeder 57. In either event, a gaseous mixture (containing fuel carried over from gas feeder 53 and/or introduced by gas feeder 57) then encounters second catalytic bed 58, which catalyzes the oxidation of the fuel and consumes at least a portion of the oxygen entrained within the stream. Heat generated by the catalytic combustion of the hydrocarbon fuel is recovered by second heat exchanger 64 as the stream proceeds downstream within reactor 20.

As indicated above, second stage 50 is configured to reduce the oxygen content of the inlet stream to about 1000 ppm or less of oxygen. The skilled person will appreciate that the configuration of second stage 50 can be manipulated to provide one catalytic combustion sub-stage or more than two catalytic combustion sub-stages. Factors that may influence the number of sub-stages include the amount of heat generated at any given catalytic combustion sub-stage, as well as the ability to recover the heat from the sub-stage. For example, it may be desirable to limit oxidation of the fuel based upon the temperature tolerances of the catalytic beds as described in greater detail below.

Once the oxygen concentration of the gaseous stream is reduced to about 1000 ppm or less, the gaseous stream is routed downstream to third stage 70 where hydrogen is oxidized, which thereby further reduces the concentration of oxygen within the stream. In one or more embodiments, hydrogen gas is introduced to the stream from hydrogen gas feeder 73. Alternatively, an intermediary, such as methanol, can be introduced to the stream, which is then converted to hydrogen gas (and water), and the hydrogen is subsequently oxidized. In any event, a gaseous mixture including hydrogen then encounters catalytic bed 74, which catalyzes the oxidation of the hydrogen and consumes at least substantially all of the remaining oxygen entrained within the stream.

### Gaseous Inlet Stream

In one or more embodiments, the gaseous inlet stream (i.e. the stream purified by reactor 20) can include a variety of gaseous streams including those that include from zero to nearly 100 percent by volume carbon dioxide. In certain situations, the inlet stream may include air, which as the skilled person understands includes significantly less than 1 volume percent carbon dioxide. In other embodiments, the inlet stream includes from about 1 to about 15 vol. %, in other embodiments greater than 15 percent by volume, in other embodiments greater than 20 percent by volume, in other embodiments greater than 25 percent by volume, and in other embodiments greater than 30 percent by volume carbon dioxide.

In one or more embodiments, reactor 20 operates at atmospheric pressure. As a result, it may be desirable to pressurize the gaseous inlet stream prior to being introduced to reactor 20 in order to facilitate movement of the gaseous stream through reactor 20. In one or more embodiments, the gaseous inlet stream is pressurized to greater than 1, in other embodiments greater than 2, and in other embodiments greater than 3 psig. In these or other embodiments, the gaseous inlet stream is pressurized to a pressure of from about 1 to about 10, in other embodiments from about 1.5 to about 7, and in other embodiments from about 2 to about 5 psig.

### Reactor Temperature Profiles

In one or more embodiments, the first stage of the reactor, which includes thermal combustion, operates at temperatures that are dictated by the amount of oxygen consumed in any sub-stage. In one or more embodiments, the thermal combustion within first stage 30 heats the gaseous stream to a temperature of from about 1400 to about 3200° F., in other embodiments from about 1700 to about 3000° F., in other embodiments from about 1900 to about 2800° F., and in other embodiments from about 2100 to about 2700° F. As the skilled person appreciates, the amount of oxygen consumed in this step can be controlled by several factors including the amount of fuel added and/or the amount of inert constituents (e.g. nitrogen or carbon dioxide) within the stream. The skilled person also understands that the amount of inert constituents can be controlled by, for example, recycle streams that can be introduced into the gaseous stream. It should also be appreciated that by controlling the temperature of the heated stream or the temperature associated with the flame, the formation of NOx and SOx can advantageously be avoided.

As the skilled person will appreciate, a desired amount of heat can be extracted from the gaseous stream via the heat exchangers within first stage 30. In one or more embodiments, where first stage 30 includes direct burners, it may be desirable to extract sufficient heat from the stream between sub-stages by heat exchanger 36 to thereby cool the stream to a desired temperature. Alternatively, where first stage 30 operates by flameless thermal oxidation, it may be desirable to maintain heat within the stream so as to limit heat requirements on downstream heaters. In one or more embodiments, where direct burners are employed, the temperature of the gaseous stream between first and second feeders 33, 37 is cooled to a temperature of from about 200 to about 700° F., in other embodiments from about 300 to about 600° F., and in other embodiments from about 350 to about 500° F.

In these or other embodiments, the temperature of the gaseous stream leaving first stage 30 and entering second stage 50, where catalytic combustion takes place, is controlled to a temperature sufficient to drive catalytic combustion without having a deleterious impact on the catalyst or substrate. As the skilled person will appreciate, the temperature of the gas stream exiting first stage 30 can be controlled by extracting heat via heat exchangers downstream of the fuel feeders (e.g. second exchanger 38, which is downstream of second fuel feeder 37). In one or more embodiments, the gaseous stream entering second stage 50 is controlled to a temperature of from about 750 to about 1000° F. and in other embodiments from about 800 to about 950° F.

Once the gaseous stream is within second stage 50, the temperature of the gaseous stream, especially the maximum temperature that the gaseous stream achieves through catalytic combustion, can be controlled by the extent of catalytic combustion (i.e. the oxidation of the hydrocarbon fuel introduced to the stream). As the skilled will appreciate, the extent of catalytic combustion can be controlled by the amount of hydrocarbon fuel introduced to the gaseous stream. In one or more embodiments, the amount of fuel introduced to the gaseous stream is regulated to ensure that catalytic combustion heats the stream to a temperature of at most 1300 ° F., in other embodiments at most 1200° F., and in other embodiments at most 1150° F.

In those embodiments where second stage 30 includes first and second catalytic beds 54, 58, it may be desirable to extract sufficient heat from the stream between first and second catalytic beds 54, 58 to thereby cool the stream to a temperature of from about 750 to about 1000° F., or in other embodiments from about 800 to about 950° F., prior to delivery of the gaseous stream to second catalytic bed 58. As with first catalytic bed 54, the hydrocarbon fuel introduced to the gaseous stream prior to introducing the gaseous stream to the second catalytic bed stream is regulated to ensure that catalytic combustion heats the stream to a temperature of at most 1300° F., in other embodiments at most 1200° F., and in other embodiments at most 1150° F.

In one or more embodiments, the temperature of the gaseous stream leaving second stage 50 and entering third stage 70, where oxidation of hydrogen takes place, is controlled to a temperature sufficient to drive catalytic oxidation of hydrogen without having a deleterious impact on the catalyst or substrate within third zone 70. As the skilled person will appreciate, the temperature of the gas stream exiting second stage 50 can be controlled by extracting heat via heat exchangers downstream of the catalytic beds (e.g. second heat exchanger 64, which is downstream of second catalytic bed 58). In one or more embodiments, the gaseous stream entering third stage 70 is controlled to a temperature of from about 280 to about 500° F., in other embodiments from about 300 to about 450° F., and in other embodiments from about 320 to about 400° F.

### Catalytic Beds

The catalytic combustion beds generally include an appropriate metal catalyst on an appropriate support, which may also be referred to as a substrate. An intermediary high-surface area layer may be present between the catalyst metals and the support. Useful metal catalysts include palladium, platinum, and rhodium. The intermediary layer, which can be deposited in the form of a washcoat, may include alumina, hexaaluminates, and perovskites. The support may include monolithic honeycomb structures or metallic alloy foils such as those prepared from iron-chrome-aluminum alloys.

The catalyst beds for reacting oxygen and hydrogen generally include an appropriate metal catalyst on an appropriate support. An intermediary high-surface area layer may be present between the catalyst metals and the support. Useful metal catalysts include platinum. The intermediary layer, which can be deposited in the form of a washcoat, may include alumina, hexaaluminates, and perovskites. The support may include monolithic honeycomb structures or metallic alloy foils such as those prepared from iron-chrome-aluminum alloys.

### Control Scheme

In one or more embodiments, reactor 20 is equipped with a control system that regulates operation of the reactor in real time to achieve the desired oxygen reduction without reaching deleterious conditions (e.g. temperatures) within any of the given zones or stages. For example, the inlet and outlet of each stage and/or sub-stage can include oxygen and/or temperature sensors. The fuel feed lines (e.g. hydrocarbon fuel feed lines 31, 35, 51, and 55, as well as hydrogen feed line 71) can be controlled with actuators that regulate the flow of fuel into the gaseous stream. Information obtained from the oxygen and temperature sensors can be used to control the fuel feed lines through, for example, a control processing unit, in real time to thereby achieve the desired temperature profile with reactor 20 and/or desire level of oxygen reduction.

### OUTLET STREAM

As indicated above, the gaseous stream exiting reactor 20 via outlet 26 is substantially devoid of oxygen. In one or more embodiments, the gaseous stream exiting reactor 20, which may also be referred to as the outlet stream, includes less than 10 ppmv (parts per million by volume), in other embodiments less than 5 ppmv, and in other embodiments less than 1 ppmv oxygen.

### Downstream Carbon Dioxide Purification

The gaseous stream exiting reactor 20 can be further processed to purify and further concentrate the carbon dioxide content of the stream and thereby provide a highly-concentrated carbon dioxide stream. The skilled person will appreciate that the outlet stream (i.e. the stream exiting reactor 20) may contain appreciable amounts of nitrogen. For example, the outlet stream could include from about 1 to about 35 % or from about 3 to about 25% (vol) nitrogen. Therefore, in one or more embodiments, downstream carbon dioxide purification and concentration may include known techniques for separating carbon dioxide and nitrogen. These techniques may include, but are not limited to, membrane separation, amine scrubbing, and/or cryogenic distillation.

In one or more embodiments, the gaseous stream exiting reactor 20 can undergo treatment to dehydrate the stream. For example, dehydration may be useful prior to membrane separation. In these or other embodiments, dehydration may be useful for subsequent transport or storage. As the skilled person appreciates, dehydration may be required to avoid corrosion of metal surfaces used to transport or store the highly-concentrated carbon dioxide streams. For example, the carbon dioxide product stream is dehydrated to achieve a gaseous stream including less than 700 ppmv (e.g. less than 25 lbs water per million standard cubic feet of gas), in other embodiments less than 500 ppmv, and in other embodiments less than 400 ppmv water. An exemplary dehydration unit may include triethylene glycol system.

In one or more embodiments, pressurization of the highly-concentrated carbon dioxide stream may be required. In one or more embodiments, the highly-concentrated stream exiting the catalytic oxidation sub-system can be pressurized by using one or more pumps. In one or more embodiments, the highly-concentrated stream exiting catalytic oxidation sub-system, optionally exiting dehydration, is pressurized to greater than 15, in other embodiments greater than 30, in other embodiments greater than 40, and in other embodiments greater than 50 psig prior to introduction into nitrogen separation sub-system 80. In one or more embodiments, the gaseous stream is pressurized to a pressure of from about 30 to about 120, in other embodiments from about 40 to about 110, and in other embodiments from about 50 to about 100 psig prior to being introduced to a membrane sub-system for nitrogen separation. It will also be appreciated that depending on the nature of the nitrogen separation, pressurization of the stream may take place downstream of the nitrogen separation. For example, where nitrogen separation takes place by amine scrubbing, pressurization of the carbon dioxide stream resulting from amine scrubbing may be pressurized downstream and the need to pressurize upstream of nitrogen separation may be eliminated.

In any event, the highly-concentrated carbon dioxide stream, which is also substantially free of oxygen and nitrogen, is pressurized for further use or transport. This stream may also be referred to as the carbon dioxide product stream. In one or more embodiments, the highly-concentrated stream (i.e. carbon dioxide product stream) is ultimately pressurized to greater than 250, in other embodiments greater than 300, and in other embodiments greater than 350 psig prior to introduction into nitrogen separation sub-system 80. In one or more embodiments, the gaseous stream is pressurized to a pressure of from about 250 to about 2500, in other embodiments from about 275 to about 1000 psig prior to introduction into nitrogen separation sub-system 80. In one or more embodiments, the carbon dioxide product stream is made supercritical through a combination of pressure and temperature for transport. The skilled person understands that at pressures below about 1000 psig, the carbon dioxide product stream will require cryogenic cooling in order to achieve proper conditions for transport.

### INDUSTRIAL APPLICABILITY

The multi-stage carbon dioxide purification processes and systems of the present invention have many industrial applications.

### High-Concentration Carbon Dioxide Streams

In one or more embodiments, the processes and systems of this invention are used to treat relatively pure (i.e. high concentration) carbon dioxide streams, such as those obtained from direct air capture techniques or recovered from ethanol processes. As the skilled person appreciates, these high-concentration carbon dioxide gaseous streams may include in excess of 75%, or 85%, or 95% by volume carbon dioxide and less than about 20%, or 12%, or 5%, or 3% nitrogen. These streams may include, however, up to about 3% oxygen. In these embodiments, the primary target for purification of the gaseous streams is removal of oxygen. Practice of the present invention therefore offers a unique solution to purify these carbon dioxide streams. As suggested by the discussion above, these streams can be treated according the present invention in the absence of direct combustion; i.e. the streams can be delivered directly to catalytic combustion (e.g. the second stage described above), since these streams may include less than 30,000 ppmv oxygen.

### Low-Concentration Carbon Dioxide Streams

In other embodiments, the processes and systems of this invention are used to treat streams including lower levels of carbon dioxide, such as flue gas streams obtained from natural gas or coal-fired power plants, as well as flue gas streams from the production of cement. These gaseous streams may include up to about 30% by volume carbon dioxide, 60% to about 80% nitrogen, and up to about 15% oxygen. For example, as the skilled person appreciates, natural gas turbines typically produce flue gas streams with about 3 vol. % carbon dioxide, coal plants typically produce flue gas streams with about 12 vol. % carbon dioxide, and cement plants produce flue gas streams with about 25 vol. % carbon dioxide. The process and system of the present invention therefore offers a unique solution to reduce the oxygen content of these streams, which then allows the streams to be subsequently purified to remove nitrogen and thereby produce a relatively pure carbon dioxide stream.

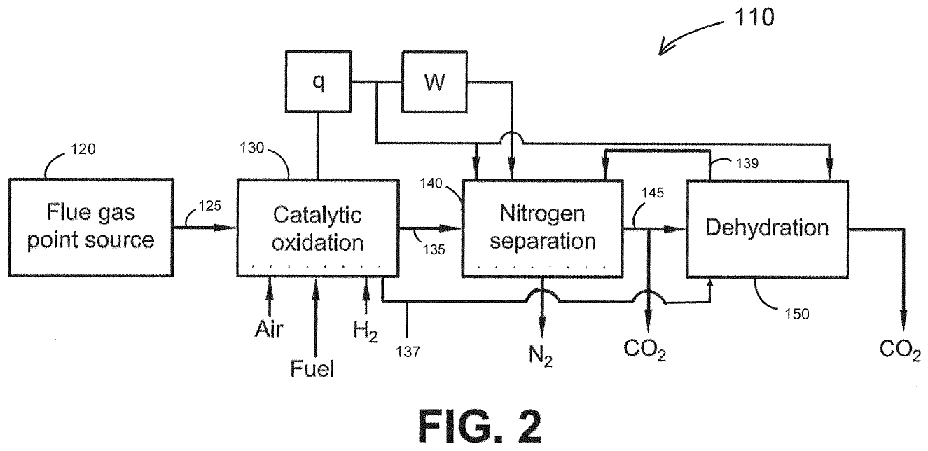

An exemplary system for flue gas handling is shown in FIG. 2, which shows system 110 including flue gas point source 120, catalytic oxidation unit 130, optional nitrogen separation unit 140, and optional dehydration unit 150. Flue gas point source is in fluid communication with catalytic oxidation unit 130 via conduit 125, catalytic oxidation unit 130 is in fluid communication with nitrogen separation unit 140 via conduit 135 or dehydration unit 150 via conduit 137, nitrogen separation 140 is in fluid communication with dehydration unit 150 via conduit 145, and dehydration unit 150 is in fluid communication with nitrogen separation unit 150 via conduit 139.

Since catalytic oxidation unit 130, which is a unit according to one or more embodiments of the present invention, advantageously operates at atmospheric pressure, flue gas may be routed directly to catalytic oxidation unit 130 from point source 120 by optionally pressurizing the stream. The skilled person understands that pressurization can be accomplished through one or more blowers or pumps upstream of unit 130. In one or more embodiments, the stream is pressurized to greater than 1, in other embodiments greater than 2, and in other embodiments greater than 3 psig prior to introduction into unit 130. In one or more embodiments, the gaseous stream is pressurized to a pressure of from about 1 to about 10, in other embodiments from about 1.5 to about 7, and in other embodiments from about 2 to about 5 psig. In one or more embodiments, depending on the temperature of the flue gas inlet stream, it may also be desirable to adjust the temperature of the fuel gas prior to feeding the flue gas stream to catalytic oxidation unit 130.

Within catalytic oxidation unit 130, the flue gas stream is treated within a multi-stage process, as described above, to reduce the oxygen level of the stream (e.g. reduce to less than 10 ppmv). It will be appreciated that depending on oxygen content of the inlet stream, the first stage (i.e. thermal combustion) may not be required. Or, where there is a desire to generate heat, and the inlet stream does not include sufficient oxygen that is required to generate the desired heat, oxygen (typically from an air inlet) can be added to the system.

Heat energy generated (q) generated by catalytic oxidation unit 130 can be captured and used elsewhere in the process. For example, heat energy (q) can be captured and converted to mechanical energy (W) that can be used to drive compression that may be useful in downstream operations such as within nitrogen separation unit 140 where nitrogen separation unit employs membrane technologies to separate carbon dioxide from nitrogen within the stream. In other embodiments, heat energy (q) can be converted to electrical energy and used elsewhere in the process, such as within downstream separation processes or to power electric heaters. Still further, heat energy (q) can be used directly within other sub-processes or units such amine separation units. It will be appreciated that the capture and use of heat energy (q) generated by catalytic oxidation unit 130 provides overall efficiencies based upon the fact that the energy is created without the need to process additional nitrogen through the system.

It will be appreciated that oxygen consumption within catalytic oxidation unit 130 provides an outlet stream that includes a greater concentration of carbon dioxide than the point source flue gas since carbon dioxide is a by-product of the oxidation process. This may be advantageous for downstream separation processes that operate more efficiently at higher carbon dioxide concentrations.

With reference again to FIG. 2, the oxygen-reduced stream exiting catalytic oxidation unit 130 is routed, via conduit 135, to nitrogen separation unit 140 wherein the carbon dioxide stream is further concentrated. In one or more embodiments, the stream exiting the overall process, especially that stream exiting after nitrogen separation, can be concentrated to greater than 90 vol. %, in other embodiments greater than 94 vol. %, and in other embodiments greater than 96 vol. % carbon dioxide with less than 10 ppmv, in other embodiments less than 8 ppmv, and in other embodiments less than 6 ppmv oxygen.

Dehydration unit 150, which may also be referred to as dehydration sub-subsystem 150, can be used to treat the gaseous stream upstream of nitrogen separation sub-system 140 (i.e. via conduit 139) or downstream of nitrogen separation sub-system 140 (i.e. via conduit 145). The location of dehydration unit 140 may depend on the methodology used for nitrogen separation. For example, where membrane separation techniques are used, it may be advantageous to dehydrate the stream upstream of nitrogen separation. On the other hand, where amine scrubbing is used for nitrogen separation, it may be useful to dehydrate the stream downstream of nitrogen separation. The skilled person also appreciates that nitrogen sub-system 140 can employ multiple nitrogen separation systems operating in series.

### Amine Capture Systems

In other embodiments, the processes and systems of this invention are used in conjunction with amine scrubbing systems. As the skilled person appreciates, amine scrubbing systems generally operate in an aqueous medium wherein carbon dioxide associates or otherwise binds to an amine compound, such as an alkylamine. The aqueous medium is then regenerated, typically by the introduction of heat, to thereby release the carbon dioxide and form a highly-concentrated stream of carbon dioxide. The aqueous medium including the amine can then be reintroduced to the system for subsequent carbon dioxide capture. According to embodiments of the present invention, heat generated by the oxidation of hydrocarbon fuel and/or hydrogen can be captured and used to regenerate the amine compounds. Also, practice of the present invention is advantageously combined with amine scrubbing techniques to provide highly efficient systems that are not burdened by oxidation contamination, which is detrimental to the amine compounds. Since the carbon dioxide streams of the present invention are substantially devoid of oxygen, practice of the present invention also allows for the use more efficient amine compounds that are otherwise more susceptible to oxygen degradation. For example, secondary and tertiary amines can be used.

Heat-Only Applications In other embodiments, the processes and systems of this invention are used for the primary purpose of providing heat (e.g. within a boiler or heater) with the advantage of producing a relatively pure carbon dioxide stream that can be efficiently captured and/or sequestered downstream without the need to address oxygen contamination. Within this use, the system (e.g. reactor 20) would receive an air stream (or a high-concentration oxygen stream) in lieu of a carbon dioxide stream as described above with respect to other embodiments; although the skilled person appreciates that an air stream includes some carbon dioxide. The system would otherwise operate as outlined above to provide a product stream that includes increased levels of carbon dioxide and is substantially free of oxygen, together with desired heat.

Various modifications and alterations that do not depart from the scope and spirit of this invention will become apparent to those skilled in the art. This invention is not to be duly limited to the illustrative embodiments set forth herein.

1. A process for the purification of carbon dioxide streams, the process comprising:
(a) providing a gaseous stream including carbon dioxide and oxygen, where the gaseous stream includes less than 30,000 ppmv oxygen;
(b) introducing a hydrocarbon fuel to the gaseous stream to thereby form a fuel-containing gaseous mixture;
(c) oxidizing at least a portion of the hydrocarbon fuel within the fuel-containing gaseous mixture in the presence of a catalyst and the absence of flame to thereby provide an oxygen-reduced gaseous stream, where the oxygen-reduced gaseous stream includes less than 1000 ppmv oxygen;
(d) introducing hydrogen or a hydrogen intermediary to the oxygen-reduced gaseous stream to thereby form a hydrogen-containing gaseous mixture; and
(e) oxidizing at least a portion of the hydrogen within the hydrogen-containing gaseous mixture in the presence of a catalyst to thereby substantially consume all oxygen within the hydrogen-containing gaseous stream and provide an oxygen-purified carbon dioxide stream.

2. The process of claim 1, where said step of providing a gaseous stream including carbon dioxide and oxygen includes providing an inlet stream including greater than 30,000 ppmv oxygen and subjecting the inlet stream to thermal oxidation to thereby consume at least a portion of the oxygen within the inlet stream and thereby provide the gaseous stream that includes less than 30,000 ppmv oxygen.

3. The process of claim 1, where the gaseous stream including carbon dioxide and oxygen includes at least 15 percent by volume carbon dioxide.

4. The process of claim 2, where said step of subjecting the inlet stream to thermal oxidation heats the gaseous stream to a temperature of from about 1400 to about 3200° F.

5. The process of claim 1, where the gaseous stream including carbon dioxide and oxygen is adjusted to a temperature of from about 750 to about 1000° F. prior to said step of oxidizing at least a portion of the hydrocarbon fuel within the fuel-containing gaseous mixture in the presence of a catalyst.

6. The process of claim 1, where, during said step of oxidizing at least a portion of the hydrocarbon fuel within the fuel-containing gaseous mixture in the presence of a catalyst, the fuel-containing gaseous mixture is maintained at a temperature of at most 1300 ° F.

7. The process of claim 1, where the oxygen-reduced gaseous stream is adjusted to a temperature of from about 280 to about 500° F. prior to said step of oxidizing at least a portion of the hydrogen within the hydrogen-containing gaseous mixture in the presence of a catalyst.

8. The process of claim 1, where oxygen-purified carbon dioxide stream includes less than detectable amounts of oxygen.

9. The process of claim 1, further comprising the step of further purifying the oxygen-purified carbon dioxide stream by separating the carbon dioxide from any nitrogen within the stream.

10. The process of claim 1, where said step of oxidizing at least a portion of the hydrocarbon fuel within the fuel-containing gaseous mixture in the presence of a catalyst produces heat, and further comprising the step of capturing at least a portion of the heat.

11. The process of claim 10, where the heat is used as process heat.

12. The process of claim 10, where the heat is used to produce steam.

13. The process of claim 10, where the heat is used to regenerate an amine scrubbing reagent for carbon dioxide capture.

14. The process of claim 2, where the inlet stream is a stream obtained from a direct air capture unit, an ethanol production process, a natural gas turbine flue gas stream, a cement production flue gas stream, a coal-fired flue gas stream, or an oxy-fired flue gas stream.

15. The process of claim 1, where the process further includes subjecting the oxygen-purified stream to amine scrubbing.

16. A carbon capture process, the process comprising:
(a) providing a flue gas, where said flue gas includes carbon dioxide, nitrogen, and greater than 3 vol. % oxygen;
(b) introducing a hydrocarbon fuel to said flue gas and thermally oxidizing the hydrocarbon fuel to thereby reduce a portion of the oxygen within the flue gas stream to provide a first oxygen-reduced flue gas stream including less than 3 vol. % oxygen;
(c) introducing a hydrocarbon fuel to said oxygen-reduced flue gas stream and catalytically oxidizing the hydrocarbon fuel to thereby reduce a portion of the oxygen within the oxygen-reduced flue gas stream to provide a second oxygen-reduced flue gas stream including less than 1 vol. % oxygen; and
(d) introducing hydrogen or a hydrogen-generating intermediary to the second oxygen-reduced flue gas stream and catalytically oxidizing the hydrogen to thereby reduced at least a portion of the oxygen within the second oxygen-reduced flue gas stream to provide a third oxygen-reduced flue gas stream including less than 10 ppmv oxygen.

17. The process of claim 16, where the flue gas includes from about 3 to about 25 vol. % carbon dioxide.

18. The process of claim 16, where the process further includes separating nitrogen from the third oxygen-reduced flue gas stream.

19. The process of claim 16 where the process further includes separating water from the third oxygen-reduced flue gas stream.

20. The process of claim 16, where the process further includes pressurizing the third oxygen-reduced flue gas stream.
